(19) United States
(12) Patent Application Publication
(10) Pub. No.: US 2016/0290831 A1
(43) Pub. Date: Oct. 6, 2016

(54) ENCODER DISC

(71) Applicant: SCHAEFFLER TECHNOLOGIES AG & CO. KG, Herzogenaurach (DE)

(72) Inventors: Carsten Ohr, Charlotte, NC (US); Brian Lee, York, SC (US)

(73) Assignee: SCHAEFFLER TECHNOLOGIES AG & CO. KG, Herzogenaurach (DE)

(21) Appl. No.: 14/676,920

(22) Filed: Apr. 2, 2015

(51) Int. Cl. G01D 5/20

(52) U.S. Cl. CPC G01D 5/20

(57) ABSTRACT

A position sensor for a bearing arrangement is provided. The position sensor includes at least one shaft or bearing ring, an inductive sensor, and a marking ring connected to the at least one shaft or bearing ring. The position sensor includes at least one shaft or bearing ring, an inductive sensor, and a marking ring connected to the at least one shaft or bearing ring. The marking ring is spaced apart from and aligned with the inductive sensor, and includes a non-ferrous body with ferrous material inserts located in the non-ferrous body adapted to pass in proximity to the inductive sensor upon rotation of the marking ring. The inductive sensor detects a rotational angle position of the at least one shaft or bearing ring based on at least one of a size or location of the ferrous material inserts as they pass the inductive sensor.

### FIELD OF INVENTION

The present invention relates to a bearing arrangement used to detect torque and angular speed of a supported shaft or bearing ring.

### BACKGROUND

Bearing arrangements including sensors for detecting a position of the bearing are known. Known position sensors for bearing arrangements typically require an inductive sensor and a marking ring or encoder disc including a wavy surface comprised of a ferrous material. The inductive sensor detects a rotational angle position of a shaft or bearing ring connected to the marking ring based on a proximity of the wavy surface to the inductive sensor. Due to the projections and valleys along the wavy surface of the marking ring, the marking ring can collect debris or contaminants, causing interference of the magnetic flux between the ferrous marking ring and the inductive sensor and incorrect position readings. It would be desirable to provide a simple way to prevent the marking ring from collecting debris and contaminants. Further, it would be desirable to manufacture a marking ring with reduced cost and reduced weight.

### SUMMARY

A position sensor for a bearing arrangement with a simplified configuration that prevents debris and contaminants from adhering to a marking ring or encoder disc is provided. The position sensor includes at least one shaft or bearing ring, an inductive sensor, and a marking ring connected to the at least one shaft or bearing ring. The marking ring is spaced apart from and aligned with the inductive sensor, and includes a non-ferrous body with ferrous material inserts located in the non-ferrous body adapted to pass in proximity to the inductive sensor upon rotation of the marking ring. The inductive sensor detects a rotational angle position of the at least one shaft or bearing ring based on at least one of a size or location of the ferrous material inserts as they pass the inductive sensor.

In one aspect, the ferrous material inserts all have a same size and a circumferential distance between at least some of the ferrous material inserts is varied. Alternatively, at least some of the ferrous material inserts have different sizes, and a circumferential distance between adjacent ones of the ferrous material inserts is the same.

In another aspect, a thickness and/or a length of at least some of the ferrous material inserts is varied.

In another aspect, at least some of the ferrous material inserts have different sizes, and a circumferential distance between adjacent ones of at least some of the ferrous material inserts is varied.

In another aspect, the non-ferrous body is made of a polymeric material. The insets are preferably molded or cast into the non-ferrous body. This allows for light weight as well as low cost production, for example by insert molding.

In another aspect, the inductive sensor is located along a radial edge of the marking ring. Alternatively, the inductive sensor is located along an axial region of the marking ring.

In another aspect, a seal can be arranged between the inductive sensor and the marking ring.

Those of skill in the art will recognize that one or more of these features can be combined together in order to achieve certain objectives depending on the particular application.

A method of detecting a rotational angle position of at least one shaft or bearing ring of a bearing arrangement is also provided. The method includes: providing at least one shaft or bearing ring, an inductive sensor, and a marking ring connected to the at least one shaft or bearing ring, spaced apart from and aligned with the inductive sensor. The marking ring includes a non-ferrous body with ferrous material inserts located in the non-ferrous body adapted to pass in proximity to the inductive sensor upon rotation of the marking ring. The method includes detecting a rotational angle position of the at least one shaft or bearing ring based on an inductive field variance due to at least one of a size or location of the ferrous material inserts as they pass the inductive sensor.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 shows a front plan view of a position sensor according to a first embodiment.

FIG. 2 is a cross-sectional view along line 2-2 in FIG. 1.

FIG. 3 shows a side view of the position sensor of FIG. 1.

FIG. 4 shows a top view of a position sensor according to a second embodiment.

FIG. 5 is a cross-sectional view along line 5-5 in FIG. 4.

FIG. 6 shows a side view of the position sensor of FIG. 4.

FIG. 7 shows a front plan view of a position sensor according to a third embodiment.

FIG. 8 is a cross-sectional view along line 8-8 in FIG. 7.

FIG. 9 shows a side view of the position sensor of FIG. 7.

FIG. 10 shows a top view of a position sensor according to a fourth embodiment.

FIG. 11 is a cross-sectional view along line 11-11 in FIG. 10.

FIG. 12 shows a side view of the position sensor of FIG. 10.

FIG. 13 shows a front plan view of a position sensor according to a fifth embodiment.

FIG. 14 is a cross-sectional view along line 14-14 in FIG. 13.

FIG. 15 shows a side view of the position sensor of FIG. 13.

FIG. 16 shows a top view of a position sensor according to a sixth embodiment.

FIG. 17 is a cross-sectional view along line 17-17 in FIG. 16.

FIG. 18 shows a side view of the position sensor of FIG. 16.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as, for example, “at least one of a or b” (where a and b represent the items being listed) means any single one of the items a or b, or a combination of a and b thereof. This would also apply to lists of three or more items in like manner so that individual ones of the items or combinations thereof are included. The terminology includes the words specifically noted above, derivatives thereof and words of similar import.

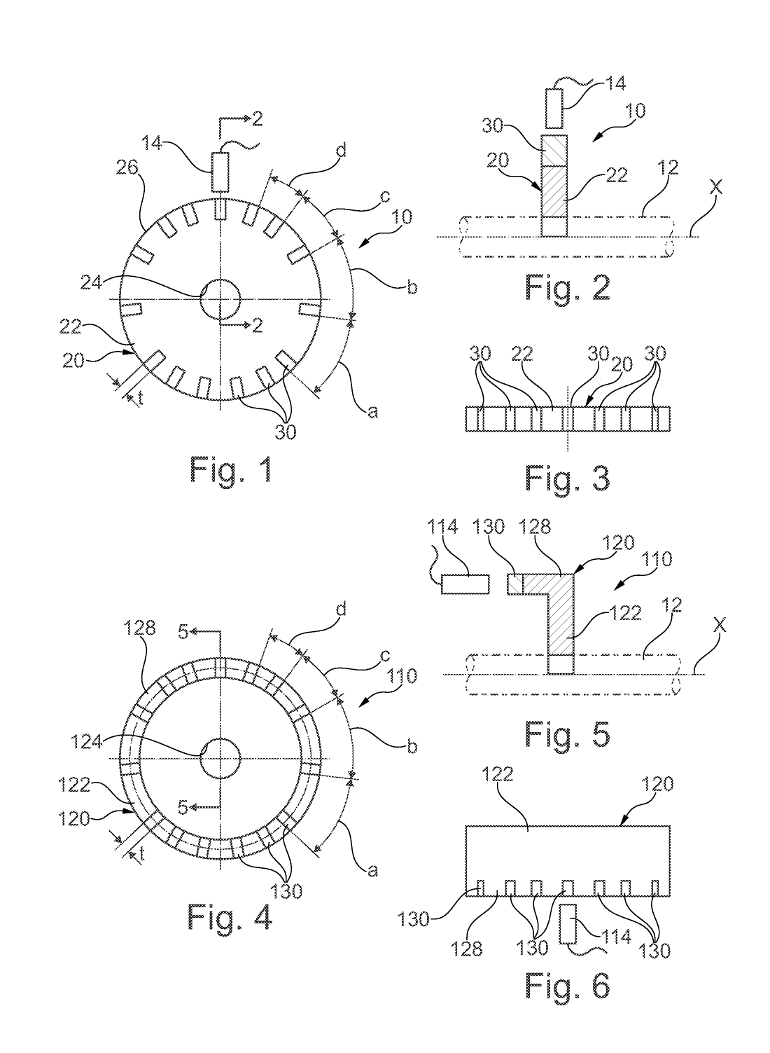

Referring to FIGS. 1-3, a first embodiment of a position sensor 10 for a bearing arrangement is shown. The position sensor 10 includes at least one shaft 12 or bearing ring and an inductive sensor 14. The shaft rotates about an axis x and the position is detected using the inductive sensor 14 which is aligned with an encoder disc or marking ring 20 that is connected to the at least one shaft 12 or bearing ring. The marking ring 20 is spaced apart from and aligned with the inductive sensor 14. In the first embodiment, the sensor 14 is radially aligned with a circumferential edge 26 of the marking ring 20.

As shown in detail in FIGS. 1 and 2, the marking ring 20 includes a non-ferrous body 22, preferably formed of a non-magnetic, more preferably polymeric, material. Ferrous material inserts 30 are located in the non-ferrous body 22, preferably about the periphery. The body 22 preferably also includes an opening 24 for the shaft 12. The ferrous material inserts 30 are adapted to pass in proximity to the inductive sensor 14 upon rotation of the marking ring 20 with the shaft 12 about the axis x. As shown in detail in FIG. 1, in the first embodiment the ferrous material inserts 30 preferably all have the same size. However, a circumferential distance, for example a, b, c, d as illustrated, between at least some of the ferrous material inserts 30 is varied. Here, the inductive sensor 14 sends a signal to a controller, not shown, which can accurately detect a position of the shaft 12 or bearing ring based on the signal profile generated due to the variation in circumferential distance between at least some of the ferrous material inserts. In the embodiment of FIGS. 1-3, the inserts 30 have a thickness t indicated in FIG. 1 and preferably have a height that is equivalent to the non-ferrous body 22 as shown in FIGS. 2 and 3. However, the height could be smaller than the body 22. A radial depth of the ferrous material inserts 30 is also the same. A suitable material for the ferrous material inserts 30 is iron. In a preferred embodiment, the inserts are molded or cast into the non-ferrous body 22, preferably in an insert molding process or in an injection molding process, with the non-ferrous body being made of a polymeric material, such as PA 48 or PA 66. The inserts 30 are either flush with or embedded within the non-ferrous body 22 so that there are no spaces for trapping and collecting dirt or debris that could negatively influence the sensor reading. Other materials could be used based on a particular application as long as they do not interfere with the magnetic flux generated by the sensor 14.

Referring to FIGS. 4-6, a second embodiment of the position sensor 110 is shown. The position sensor 110 includes the inductive sensor 114 and an encoder disc or marking ring 120 that is mounted on the shaft 12. Here, the marking ring includes the non-ferrous body 122 that extends radially, along with a preferably integrally formed axial flange 128. Ferrous material inserts 130 having the same size as one another are attached to the axial flange 128, preferably by insert molding or casting. Other means of attachment may also be utilized, if desired. Here, the inductive sensor 114 is located along an axial region of the marking ring 120. As in the first embodiment, the inductive sensor 114 detects a rotational angle position of the at least one shaft 12 or the bearing ring based on at least one of a size or location of the ferrous material inserts 130 as they pass the inductive sensor 114. In this embodiment, the location of the ferrous material inserts 130 is varied and all of the ferrous material inserts 130 have the same size. Preferably, the ferrous material inserts 130 are made of iron and the non-ferrous body 122 is made of a polymeric material, such as PA. The inserts 130 are either flush with or embedded within the non-ferrous body 122 so that there are no spaces for trapping and collecting dirt or debris that could negatively influence the sensor reading.

As shown in FIG. 4, preferably an opening 124 is provided for mounting the marking ring 120 on the shaft 12. Here again, a circumferential distance, for example a, b, c, d as illustrated, between at least some of the ferrous material inserts 130 is varied.

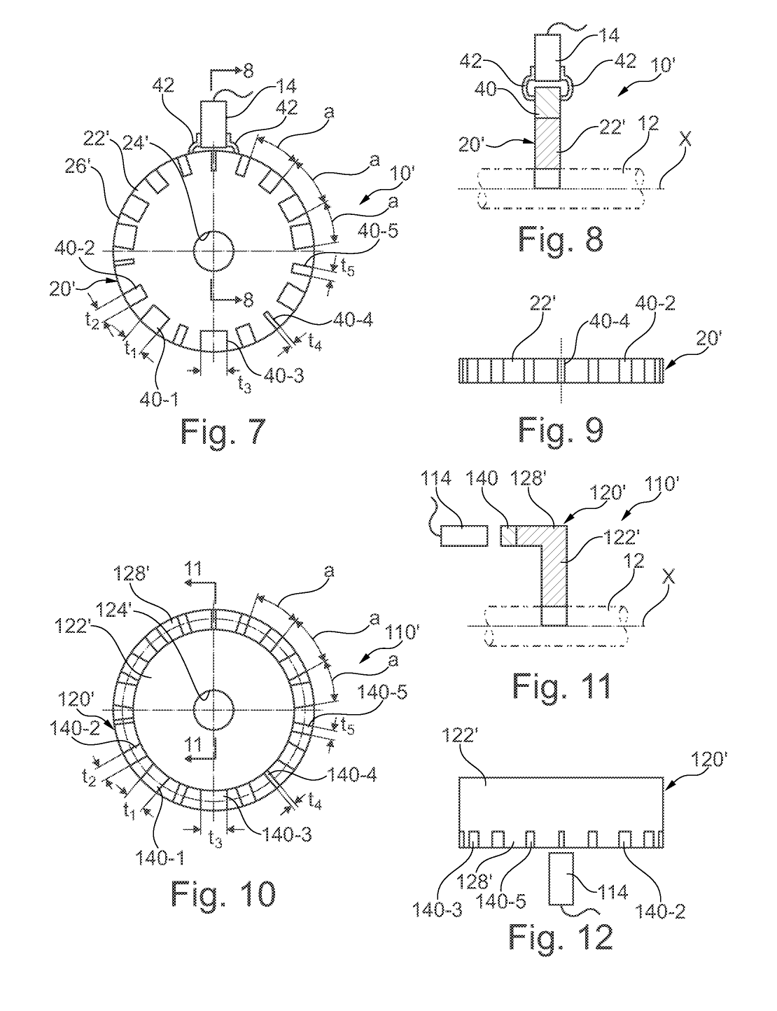

Referring now to FIGS. 7-9, the third embodiment of a position sensor 10′ is shown. The position sensor 10′ is similar to the position sensor 10 and similar reference numbers have been used to identify elements having the same or similar functions. Here, the marking ring 20′ is connected to the shaft 12. The marking ring 20′ includes a non-ferrous body 22′, similar to the non-ferrous body 22 described above. Here, ferrous material inserts 40-1, 40-2, 40-3, 40-4, and 40-5 are provided which have difference sizes and are connected to the non-ferrous body 22′ by molding or casting. In this case, a thickness t1, t2, t3, t4, t5, respectively of the inserts 40-1 through 40-5 is varied in order to provide ferrous material inserts 40 of different sizes. The height could also be varied. Here, the circumferential distance a between adjacent ones of the ferrous material inserts 40 is the same. The inductive sensor 14 detects a rotational angle position of at least one of the shafts 12 or bearing ring attached to the marking ring 20′ based on a difference in size of the ferrous material inserts 40 which is detected as a passing inductive sensor 14.

As shown in FIGS. 7 and 8, a seal 42 can optionally be provided in order to prevent debris from entering the space between the inductive sensor 14 and the marking ring 20′. While the seal 42 is only illustrated in connection with the third embodiment, those skilled in the art will recognize that a seal such as 42 can optionally be provided with each embodiment of the invention, depending upon the application.

In the third embodiment 10′, the size of the ferrous material inserts 40 is varied by changing a thickness t1, t2, t3, t4, t5 of the inserts, which allows for cost effective production of the inserts by cutting uniform bar stock at different lengths which translates to the thicknesses t1, t2, t3, t4, t5 in the marking ring 20′. However, other means for changing the size, such as by changing a length, height, and/or by providing holes through the inserts can be utilized. Providing holes in the inserts would also provide an advantage in a positive locking connection between the inserts 40 and the non-ferrous body 22′. The inserts 40-1, 40-2, 40-3, 40-4, and 40-5 are either flush with or embedded within the non-ferrous body 22′, preferably by insert molding, so that there are no spaces for trapping and collecting dirt or debris that could negatively influence the sensor reading. The third embodiment of the position sensor 10′ includes the inductive sensor 14 located along a radial edge 26′ of the marking ring 20′ in a similar manner to the first embodiment 10.

Referring now to FIGS. 10-12, a fourth embodiment of a position sensor 110′ is shown. The fourth embodiment of the position sensor 110′ is similar to the second embodiment of the position sensor 110. Here, the marking ring 120′ includes the non-ferrous body 122′ as well as the axial flange 128′ upon which the ferrous material inserts 140-1 through 140-5 are located. Preferably, the inserts 140-1 through 140-5 are connected to the non-ferrous body 122′ by molding or casting. More preferably by insert molding. As in the third embodiment, the fourth embodiment of the position sensor 110′ includes ferrous material inserts 140-1 through 140-5 having different sizes. In the fourth embodiment, a thickness t1-t5 of the ferrous material inserts 140-1 through 140-5 is varied while the circumferential distance a between the inserts 140-1 through 140-5 is the same. Preferably, the non-ferrous body 122′ is made of a polymeric material and the ferrous material inserts 140 are made of iron. Preferably the inserts 140-1 through 140-5 are connected to the non-ferrous body 122′ by insert molding, and the overall assembly is formed so that there are no spaces for trapping and collecting dirt or debris that could negatively influence the sensor reading.

Here again, the inductive sensor 114 is located along an axial region of the marking ring 120′.

While five different thicknesses t1 through t5 of the inserts 40-1 through 40-5 and 140-1 through 140-5 have been illustrated in connection with the third and fourth embodiments of the position sensor 10′, 110′, those skilled in the art will recognized that numerous different sizes can be utilized and the specific number and relative sizes indicated are merely exemplary.

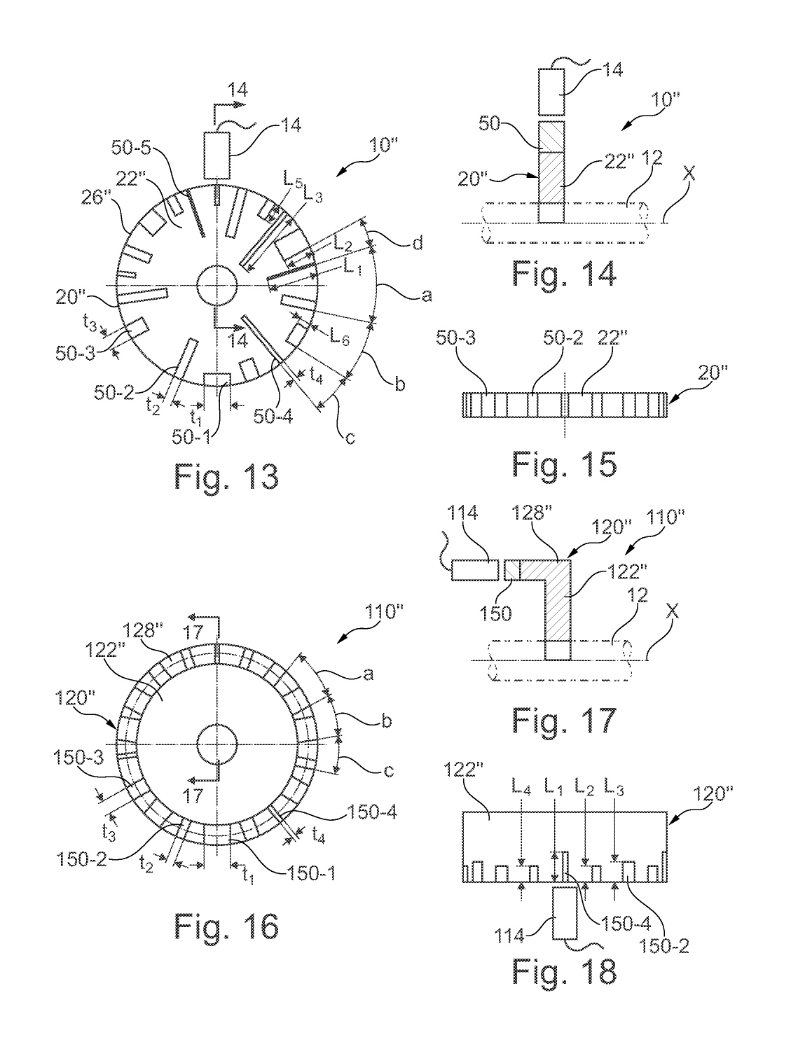

Referring now to FIGS. 13-15, the fifth embodiment of a position sensor 10″ is shown. The fifth embodiment of the position sensor 10″ is similar to the first embodiment 10 except here, inserts 50-1 through 50-5 are shown which have different sizes as indicated, for example by the different thicknesses t1 through t4 and/or also by different lengths as indicated, for example by L1-L6. Further, a circumferential distance a, b, c, d between adjacent ones of at least some of the ferrous material inserts 50-1 through 50-5 is varied. This provides for a variety of options for configuring a position wave profile to be read by the inductive sensor 14. The body 22″ is preferably made from a polymeric material and the inserts 50 are preferably made from iron. The ferrous material inserts 50-1 through 50-5 are connected to the body 22″ by molding or casting. Preferably the inserts 50-1 through 50-5 are connected to the non-ferrous body 22″ by insert molding, and the overall assembly is formed so that there are no spaces for trapping and collecting dirt or debris that could negatively influence the sensor reading.

Referring now to FIGS. 16-18, a sixth embodiment of a position sensor 110″ is shown. The position sensor 110″ is similar to the position sensor 110 in that the inductive sensor 114 is located along an axial region of the marking ring 120″ and particularly, along an axial flange 128″.

As in the fifth embodiment, here the inserts 150-1 through 150-4 have different sizes, as indicated by the different thicknesses t1 through t4, respectively, and are also set with a variable circumferential distance, for example a, b, c between adjacent ones of at least some of the ferrous material inserts 150-1 through 150-4. As shown in FIG. 18, the lengths such as L1, L2, L3, L4 of the inserts 150-1 through 150-4 can also be varied in order to specifically tailor the inductive wave profile to be read by the inductive sensor 114. Here again, the non-ferrous body 122″ is preferably molded from a polymeric material, and the ferrous material inserts 150 are made of iron. Preferably the inserts 150-1 through 150-4 are connected to the non-ferrous body 122″ by insert molding, and the overall assembly is formed so that there are no spaces for trapping and collecting dirt or debris that could negatively influence the sensor reading.

In each of the embodiments, the inserts are preferably molded or cast into the non-ferrous body, which is preferably made of polymeric material. As noted above, the seal 42 can optionally be provided between the inductive sensor 14, 114 and any of the exemplary marking rings described above.

A method of detecting a rotational angle position of at least one shaft 12 or bearing ring is also provided. Here, an inductive sensor 14, 114 is located adjacent to a marking ring 20, 20′, 20″, 120, 120′, 120″ connected to the least one shaft 12 or bearing ring. The marking rings 20, 20′, 20″, 120, 120′, 120″ are as described above. A rotation angle position of the at least one shaft 12 or bearing ring is detected based on an inductive field variance due to at least one of a size or a location of the ferrous inserts in the marking rings 20, 20′, 20″, 120, 120′, 120″ as they pass the inductive sensor.

The present position sensors allow for reduced manufacturing cost and lower weight by preferably molding the non-ferrous body with the ferrous material inserts therein. Customization of the inductive field variance to be measured is easily achieved with low cost and great flexibility through use of the variably spaced and/or sized non-ferrous inserts in the embodiments described.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A position sensor for a bearing arrangement, the position sensor comprising:
at least one shaft or bearing ring;
an inductive sensor;
a marking ring connected to the at least one shaft or bearing ring, spaced apart from and aligned with the inductive sensor, the marking ring includes a non-ferrous body and ferrous material inserts located in the non-ferrous body adapted to pass in proximity to the inductive sensor upon rotation of the marking ring;
wherein the inductive sensor detects a rotational angle position of the at least one shaft or bearing ring based on at least one of a size or location of the ferrous material inserts as they pass the inductive sensor.

2. The position sensor of claim 1, wherein the ferrous material inserts all have a same size and a circumferential distance between at least some of the ferrous material inserts is varied.

3. The position sensor of claim 1, wherein at least some of the ferrous material inserts have different sizes, and a circumferential distance between adjacent ones of the ferrous material inserts is the same.

4. The position sensor of claim 3, wherein a thickness of at least some of the ferrous material inserts is varied.

5. The position sensor of claim 3, wherein a length of at least some of the ferrous material inserts is varied.

6. The position sensor of claim 1, wherein at least some of the ferrous material inserts have different sizes, and a circumferential distance between adjacent ones of at least some of the ferrous material inserts is varied.

7. The position sensor of claim 1, wherein the non-ferrous body is made of a polymeric material.

8. The position sensor of claim 1, wherein the inserts are molded or cast into the non-ferrous body.

9. The position sensor of claim 1, wherein the inductive sensor is located along a radial edge of the marking ring.

10. The position sensor of claim 1, wherein the inductive sensor is located along an axial region of the marking ring.

11. The position sensor of claim 1, wherein a seal is arranged between the inductive sensor and the marking ring.

12. A method of detecting a rotational angle position of at least one shaft or bearing ring, the method comprising:
providing at least one shaft or bearing ring, an inductive sensor, a marking ring connected to the at least one shaft or bearing ring, spaced apart from and aligned with the inductive sensor, the marking ring including a non-ferrous body with ferrous material inserts located in the non-ferrous body adapted to pass in proximity to the inductive sensor upon rotation of the marking ring; and
detecting a rotational angle position of the at least one shaft or bearing ring based on an inductive field variance due to at least one of a size or location of the ferrous material inserts as they pass the inductive sensor.

13. The method of claim 12, wherein the ferrous material inserts all have a same size and a circumferential distance between at least some of the ferrous material inserts is varied.

14. The method of claim 12, wherein at least some of the ferrous material inserts have different sizes, and a circumferential distance between adjacent ones of the ferrous material inserts is the same.

15. The method of claim 14, wherein a thickness of at least some of the ferrous material inserts is varied.

16. The method of claim 14, wherein a length of at least some of the ferrous material inserts is varied.

17. The position sensor of claim 12, wherein at least some of the ferrous material inserts have different sizes, and a circumferential distance between adjacent ones of at least some of the ferrous material inserts is varied.
